(19) United States
(12) Patent Application Publication
(10) Pub. No.: US 2005/0013059 A1
(43) Pub. Date: Jan. 20, 2005

(54) Magnetoresistive sensor with a net magnetic moment

(75) Inventors: Hubert Grimm, Mommenheim (DE); Christian Patak, Reutlingen (DE); Johannes Paul, Mainz (DE)

Correspondence Address: William D. Gill;IBM Corporation, 5600 Cottle Road (L2PA/010), San Jose, CA, 95193, US

(73) Assignee: International Business Machines Corporation, Armonk, NY (US)

(21) Appl. No.: 10/850,952

(22) Filed: May 20, 2004

(30) Foreign Application Priority Data
Jul. 15, 2003 (DE) 03102151.2

(51) Int. Cl. G11B 5/39

(52) U.S. Cl. 360/324

(57) ABSTRACT

A magnetoresistive sensor is provided having a multilayer stack comprising a plurality of ferromagnetic layers including at least one first ferromagnetic layer and at least one second ferromagnetic layer, the first and second ferromagnetic layers being spaced apart by nonferromagnetic spacer layers that antiferromagnetically couple the ferromagnetic layers. The magnetizations of the first and second ferromagnetic layers are different resulting in the multilayer stack having a net magnetic moment.

### BACKGROUND OF THE INVENTION

1. Field of the Invention

This invention relates generally to the field of magnetoresistive sensors, and more particularly to multilayer magnetoresistive sensors, such as giant magnetoresistive multilayer sensors.

2. Description of the Related Art

A conventional magnetoresistive sensor operates on the basis of the anisotropic magnetoresistive effect. Such conventional magnetoresistive sensors provide an essentially analogue signal output wherein the resistance and hence signal output is directly related to the strength of the magnetic field being sensed.

A different and more pronounced magnetoresistance, called giant magnetoresistance (GMR), has been observed in a variety of magnetic multilayered structures, the essential feature being at least two ferromagnetic metal layers separated by a non-ferromagnetic metal layer. This GMR effect has been found in a variety of systems, such as Fe/Cr, Co/Cu, or Co/Ru multi-layers exhibiting strong antiferromagnetic coupling of the ferromagnetic layers. This GMR effect has also been observed for these types of multilayer structures, but wherein the ferromagnetic layers have a single crystalline structure and thus exhibit uniaxial magnetic anisotropy, as described in U.S. Pat. No. 5,134,533 and by K. Inomata, et al., J. Appl. Phys. 74 (6), Sep. 15, 1993.

The physical origin of the GMR effect is that the application of an external magnetic field causes a reorientation of all of the magnetic moments of the ferromagnetic layers. This in turn causes a change in the spin-dependent scattering of conduction electrons and thus a change in the electrical resistance of the multilayered structure. The resistance of the structure thus changes as the relative alignment of the magnetizations of the ferromagnetic layers changes. Magnetoresistive sensors based on the GMR effect also provide an essentially analogue signal output. A magnetoresistive sensor is known for example from U.S. Pat. No. 5,585,986.

FIG. 1 shows a schematic sectional view of a GMR sensor 100. The sensor includes a substrate 101, a seed layer 103 formed on the substrate 101 and a stack 110 of alternating ferromagnetic layers and nonferromagnetic metal spacer layers formed on seed layer 103. Seed layer 103 may comprise first and second films 104 and 105. There are nine magnetic layers 121-129 separated by eight non-ferromagnetic metal layers 131-138. The sensor 100 includes a protective or capping layer 140 and electrical leads 150, 152. The leads 150, 152 provide electrical connection to a current source 160 and a signal sensing circuit 162.

The sensor's multilayer stack 110 is preferably formed from ferromagnetic layers 121-129 of cobalt (Co) or permalloy (NiₓFe₁₋ₓ), and nonferromagnetic metallic spacer layers 131-138 of copper (Cu). Alternative ferromagnetic materials are binary and ternary alloys of Co, nickel (Ni) and iron (Fe) and alternative non-ferromagnetic metals are silver (Ag), gold (Au) and alloys of Cu, Ag and Au. Such multilayer structures exhibit GMR in that the ferromagnetic layers are antiferromagnetically coupled across the spacer layers and the relative alignments of the magnetizations of the ferromagnetic layers vary in the presence of an external magnetic field.

The stack 110 is a crystalline multilayer grown in such a manner that each of the ferromagnetic layers 121-129 exhibits an intrinsic in-plane uniaxial magnetic anisotropy. This means that in the absence of an external magnetic field the crystalline structure of each ferromagnetic layer induces the magnetization to be aligned either parallel or antiparallel to a single axis. Molecular beam epitaxy (MBE) can be used to prepare the crystalline multilayer. However, it has been shown that a crystalline multilayer can be formed by the simpler process of sputter deposition, as described for example by Harp and Parkin, Appl. Phys. Lett. 65 (24), 3063 (Dec. 12, 1994).

As shown by arrows 170-174 and oppositely directed arrows 180-183, alternate ferromagnetic layers 121-129 have their magnetizations oriented antiparallel in the absence of an external magnetic field. This antiparallel alignment is due to the intrinsic uniaxial anisotropy and the antiferromagnetic coupling across the Cu spacer layers 131-138. The Cu (or other spacer layer) thickness has to be chosen to lie within limited ranges for which the permalloy, Co, or related ferromagnetic layers are coupled antiferromagnetically. For such ranges of spacer layer thickness, GMR is observed.

FIG. 2 illustrates the sensor output performance of a sensor of the type as shown in FIG. 1 when trapezoid fluxguides are used. As apparent from comparison of the forward trace 201 and the backward trace 202 from FIG. 2, the sensor output signal is ambiguous for low field strengths which limits the sensors maximum measurement precision.

### SUMMARY OF THE INVENTION

The present invention provides for a magnetoresistive multilayer sensor having a net magnetic moment. The net magnetic moment of the multilayer sensor stack reduces or eliminates the hysteresis effects which are otherwise observed for low magnetic field strengths whereby the sensor output signal is smoothened for such low field strengths. This way the ambiguity of the sensor output signal for low field strengths is removed and the magnetoresistive sensor delivers precise measurement signals also for low magnetic field strengths.

In accordance with an embodiment of the invention, the ferromagnetic layers have different thicknesses in order to create a net magnetic moment of the multilayer stack.

In accordance with an alternative preferred embodiment of the invention, the thicknesses of juxtaposed ferromagnetic layers differ by a maximum factor of 2. Preferably the thicknesses differ by a factor of 1.2 to 1.3.

In accordance with a further alternative embodiment of the invention, juxtaposed ferromagnetic layer in the multilayer stack consist of different ferromagnetic materials having different magnetizations in order to create a net magnetic moment of the multilayer stack.

The above as well as additional objects, features, and advantages of the present invention will become apparent in the following detailed description.

### BRIEF DESCRIPTION OF THE DRAWINGS

For a fuller understanding of the nature and advantages of the present invention, as well as the preferred mode of use, reference should be made to the following detailed description read in conjunction with the accompanying drawings. In the following drawings, like reference numerals designate like or similar parts throughout the drawings.

FIG. 1 is a schematic sectional view, not to scale, of a prior art giant magnetoresistance sensor;

FIG. 2 is illustrative of an output signal delivered by a giant magnetoresistance sensor of the type as shown in FIG. 1;

FIG. 3 is a schematic sectional view, not to scale, of a giant magnetoresistance sensor according to the present invention; and

FIG. 4 is illustrative of an output signal delivered by a sensor of the type as shown in FIG. 3.

### DETAILED DESCRIPTION OF THE PREFERRED EMBODIMENT

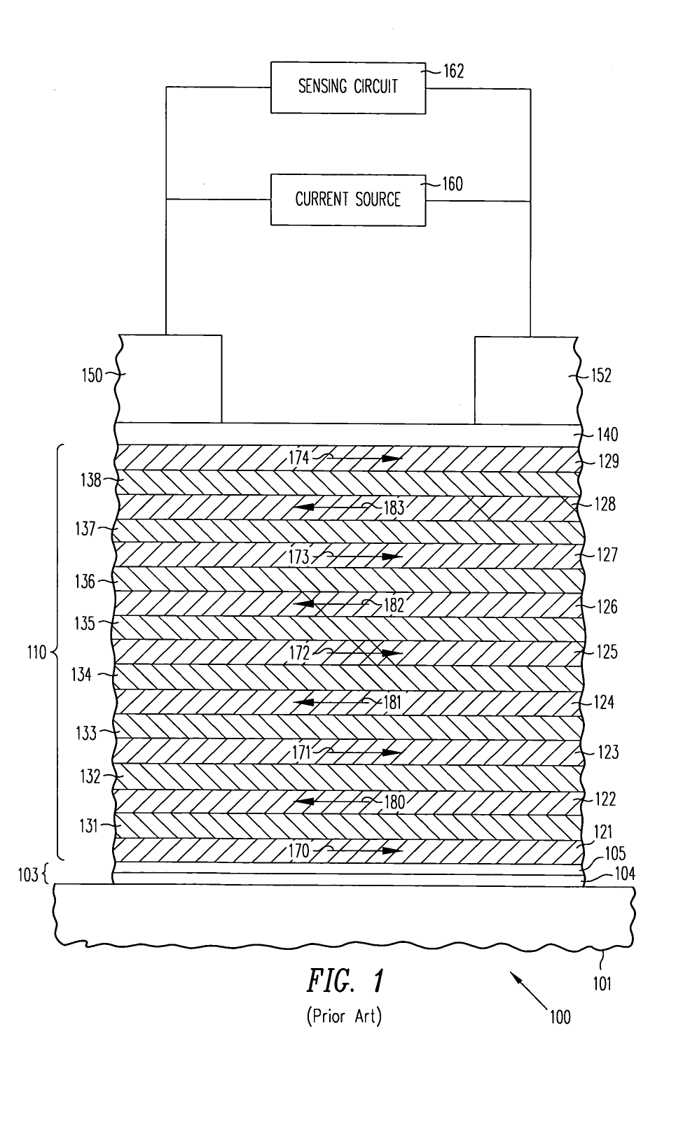

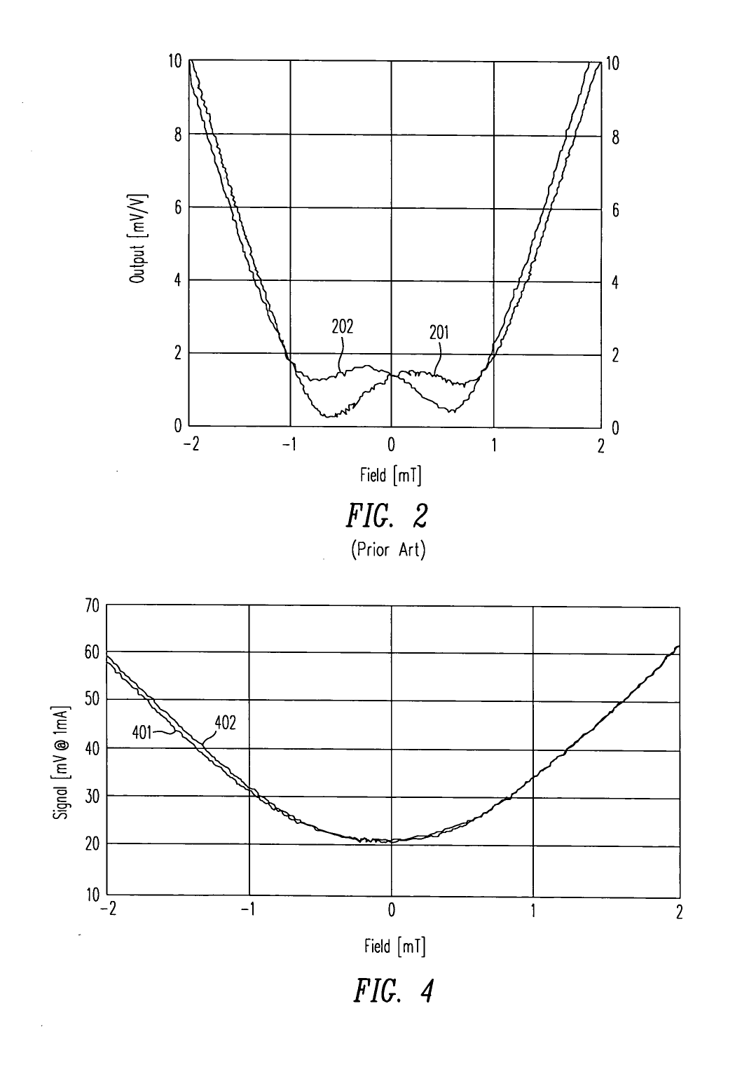

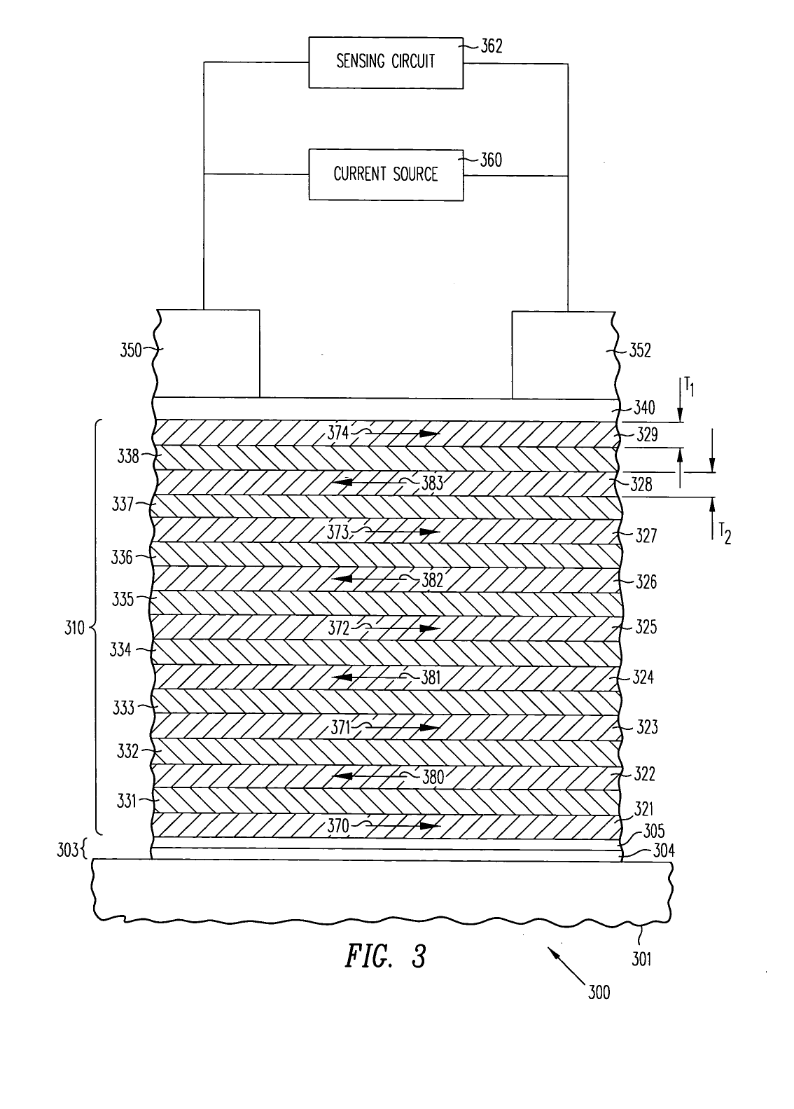

FIG. 3 shows a schematic sectional view of a magnetoresistive sensor 300 in accordance with the present invention. Elements of the sensor 300 which correspond to elements of the sensor 100 shown in FIG. 1 are designated by like reference numerals having added 200.

The sensor 300 comprises a substrate 301, a seed layer 303 formed on the substrate 301 and a stack 310 of alternating ferromagnetic layers 321-329 and nonferromagnetic metal spacer layers 331-338 formed on seed layer 303. The seed layer 303 may comprise first and second film layer 304 and 305. There are nine ferromagnetic layers 321-329 separated by eight nonferromagnetic metal layers 331-338. The sensor 300 includes a protective or capping layer 340 and electrical leads 350, 352. The leads 350, 352 provide electrical connection to a current source 360 and a signal sensing circuit 362.

As shown by arrows 370-374 and oppositely directed arrows 380-383, alternate ferromagnetic layers 321-329 have their magnetizations oriented antiparallel in the absence of an external magnetic field. This antiparallel alignment is due to the intrinsic uniaxial anisotropy and the antiferromagnetic coupling across the Cu spacer layers 131-138. The Cu (or other spacer layer) thickness has to be chosen to lie within limited ranges for which the permalloy, Co, or related ferromagnetic layers are coupled antiferromagnetically. For such ranges of spacer layer thickness, GMR is observed.

Multilayer stack 310 has a net magnetic moment. The net magnetic moment of stack 310 results from the magnetic moments of the ferromagnetic layers 321 to 329. In the example considered here first ferromagnetic layers 322, 324, 326 and 328 have lower magnetizations 380, 381, 382 and 383 than the magnetizations 370, 371, 372, 373 and 374 of second ferromagnetic layers 321, 323, 325, 327 and 329. Hence a net magnetization results from the superposition of the magnetizations of the ferromagnetic layers 321 to 329.

It will be apparent to those of ordinary skill in the art that the multilayer stack is not limited to the number of ferromagnetic layers of the illustrative sensor 300 shown in FIG. 3. The multilayer stack may, alternatively, comprise a plurality of ferromagnetic layers including at least one first ferromagnetic layer alternating with at least one second ferromagnetic layer wherein the magnetizations of the first ferromagnetic layers are different than the magnetizations of the second ferromagnetic layers. The magnetizations of the first ferromagnetic layers may be less than the magnetizations of the second ferromagnetic layers or, alternatively, may be greater than than the magnetizations of the second ferromagnetic layers.

Preferably, stack 310 is a polycrystalline multilayer grown in such a manner that each of the ferromagnetic layers 321-329 exhibits an intrinsic induced in-plane uniaxial magnetic anisotropy. If no external magnetic field is applied, the magnetizations of the individual ferromagnetic layers are oriented in antiparallel directions.

There are various options for creating a stepped magnetization profile in the multilayer stack:
1) When the same ferromagnetic material is used for all ferromagnetic layers 321 to 329, the magnetizations of individual ones of the ferromagnetic layers can be varied by varying the thicknesses of the ferromagnetic layers. For example individual ferromagnetic layers 321, 323, 325, 327 and 329 have a thickness T₁ which is about a factor 2, preferably a factor of 1.2 or 1.3, of the thickness T₂ of the individual ferromagnetic layers 322, 324, 326 and 328. In other words, thickness T₁ of ferromagnetic layers 321, 323, 325, 327, 329 is T₁=F×T₂ where T₂ is the thickness of ferromagnetic layers 322, 324, 326, 328. Preferably the factor F is less than 2; most preferably F is between 1.2 and 1.3;
2) Using different ferromagnetic materials having different magnetizations for juxtaposed ferromagnetic layers; and
3) Using different densities of ferromagnetic particles in juxtaposed ferromagnetic layers.

FIG. 4 shows the signal output provided by a magnetoresistive sensor of the type as shown in FIG. 3. As apparent from comparison of the forward trace 401 with the backward trace 402 from FIG. 4, the output signal delivered by the sensor is smooth and unambiguous even for very low field strengths. This is due to the fact that hysteresis effects are eliminated by the net magnetic moment of the multilayer stack of the sensor.

While the present invention has been particularly shown and described with reference to the preferred embodiments, it will be understood by those skilled in the art that various changes in form and detail may be made without departing from the spirit, scope and teaching of the invention. Accordingly, the disclosed invention is to be considered merely as illustrative and limited only as specified in the appended claims.

1. A magnetoresistive sensor comprising:
a multilayer stack comprising at least one of first ferromagnetic layers and at least one of second ferromagnetic layers, wherein the first and second ferromagnetic layers are spaced apart by nonferromagnetic spacer layers, and wherein the multilayer stack has a net magnetic moment.

2. The magnetoresistive sensor of claim 1, wherein the first ferromagnetic layers have a first thickness and the second ferromagnetic layers have a second thickness, and wherein the first and second thickness are substantially different.

3. The magnetoresistive sensor of claim 2, wherein the first and second thickness differ by a factor having a value less than 2.

4. The magnetoresistive sensor of claim 2, wherein the first and second thickness differ by a factor having a value in the range of 1.2-1.3.

5. The magnetoresistive sensor of claim 1, wherein the first and second ferromagnetic layers consist of different ferromagnetic materials.

6. The magnetoresistive sensor of claims 1, wherein the first and second ferromagnetic layers have different densities of ferromagnetic particles.

7. A magnetoresistive sensor comprising:
a multilayer stack including a plurality of ferromagnetic layers comprising:
at least one first ferromagnetic layer having a first magnetization;
at least one second ferromagnetic layer having a second magnetization;
a nonmagnetic conductive spacer layer disposed between each of the first ferromagnetic layers and the second ferromagnetic layers; and
wherein the multilayer stack has a net magnetic moment.

8. The magnetoresistive sensor of claim 7, wherein the first ferromagnetic layers have a first thickness and the second ferromagnetic layers have a second thickness, and wherein the first and second thickness are substantially different.

9. The magnetoresistive sensor of claim 8, wherein the first and second thickness differ by a factor having a value less than 2.

10. The magnetoresistive sensor of claim 8, wherein the first and second thickness differ by a factor having a value in the range of 1.2-1.3.

11. The magnetoresistive sensor of claim 7, wherein the first and second ferromagnetic layers consist of different ferromagnetic materials.

12. The magnetoresistive sensor of claims 1, wherein the first and second ferromagnetic layers have different densities of ferromagnetic particles.
